(19) United States
(12) Patent Application Publication
(10) Pub. No.: US 2025/0070292 A1
(43) Pub. Date: Feb. 27, 2025

(54) TERNARY POSITIVE ACTIVE ELECTRODE LEACHING

(71) Applicant: Ascend Elements, Inc., Westborough, MA (US)

(72) Inventors: Kee-Chan Kim, Westborough, MA (US); Eric Gratz, Westborough, MA (US)

(21) Appl. No.: 18/237,807

(22) Filed: Aug. 24, 2023

(51) Int. Cl. H01M 10/54; C22B 3/44; C22B 7/00

(52) U.S. Cl. CPC H01M 10/54; C22B 3/44; C22B 7/007

(57) ABSTRACT

A recycling process for cathode material of a Li-ion battery generates highly pure cathode material precursor from a leaching process using either heat treatment or an oxidizing agent. The highly pure cathode material includes cathode material metallic elements of Ni, Mn and Co, leached from a granular recycling stream of waste batteries, by a coprecipitation process that defines a molar ratio of the cathode material metals corresponding to a prescribed battery chemistry. The result is a precursor cathode active material (pCAM) in a form that may be sintered with lithium (typically lithium carbonate or lithium hydroxide) to form the cathode active material for the recycled battery, including the charge material metals in the prescribed ratio.

### BACKGROUND

Batteries for electric vehicles represent a large quantity of environmentally sensitive waste. Most batteries for electric vehicles (EVs) and hybrid vehicles are lithium-ion batteries, meaning they are composed of charge material metals along with lithium, defining a cathode material for the battery. Graphite and other carbon forms define an anode side (electrode). Among the more valuable raw materials in the batteries are the charge material metals, including nickel, manganese, and cobalt, which are combined with lithium to form active cathode material for the battery. Conventional approaches seek to recycle the cathode material for recovering at least the Ni, Mn and Co; such recycling is environmentally and economically beneficial.

### SUMMARY

The disclosed lithium-ion battery recycling process recovers valuable cathode materials from exhausted or spent Li-ion battery cells. Recycling typically involves physical grinding and crushing of old battery and battery packs from a recycling stream, sourced, for example, from end-of-life electric vehicles. The resulting granular material, called a black mass, includes comingled cathode materials, comprising metallic elements (such as Ni, Co, and Mn) along with anode materials (such as graphite). Other impurity materials, such as copper, iron, and aluminum, may also be present in residual quantities.

Acid leaching has been employed for extracting and recycling charge material metals from a black mass of granulated material in a recycling stream from crushed, ground or otherwise agitated battery waste. For example, in a conventional approach, an acid leach of a black mass including Ni, Mn and Co (NMC) results in an acidic aqueous leach solution of these as metal salts. Typically, to accomplish efficient leaching, a leach additive such as an oxidizing agent or reducing agent is included to convert the metallic elements in the black mass to the desired oxidation state to form the dissolved metal salts. However, in the present disclosure, it has surprisingly been found that efficient leaching can occur without the use of a leach additive by heat treating the black mass prior to leaching. Alternatively, if no heat treatment is used, it has been found that the use of various selected oxidizing agents, rather than any reducing agents, can also achieve efficient leaching.

Thus, in the present recycling process, a black mass from a recycled lithium-ion battery stream is leached with a leaching agent to obtain an aqueous acidic leach solution of metal salts comprising a nickel salt, a cobalt salt, and a manganese salt. In one configuration, the black mass is heat treated at a temperature of >400° C. prior to leaching with the leaching agent and the leaching agent does not comprise a leach additive that is an oxidizing agent or a reducing agent. In another configuration, the black mass is not heat treated prior to leaching with the leaching agent and the leaching agent comprises a leach additive that is an oxidizing agent and is selected from the group consisting of a peroxide, a persulfate, a hypochlorite, a chlorite, a chlorate, a perchlorate, a halide, a permanganate, a nitrate, nitrous oxide, nitrogen dioxide, ozone, or oxygen. The relative amounts of the metal salts in the resulting aqueous acidic leach solution are then adjusted to achieve a targeted ratio of metals, which are then coprecipitated to form a highly pure cathode material precursor having the target ratio of metals. The precursor cathode active material (pCAM) is in a form that may be sintered with lithium (such as lithium carbonate or lithium hydroxide) to form a final cathode active material (CAM) for use in new batteries.

### BRIEF DESCRIPTION OF THE DRAWINGS

The foregoing and other features will be apparent from the following description of particular embodiments disclosed herein, as illustrated in the accompanying drawings in which like reference characters refer to the same parts throughout the different views. The drawings are not necessarily to scale, emphasis instead being placed upon. illustrating the principles of the invention.

FIG. 1 is a process flow of black mass processing according to configurations herein;

FIG. 2 is a result of an example use case comparing sodium persulfate as a leach additive; and

FIG. 3 shows results of a use case comparing heat treatment prior to leaching.

### DETAILED DESCRIPTION

A recycling process for Li-ion batteries is described in an example manner for demonstrating the benefits of heat treating granularized battery charge material including cathode material (black mass) prior to leaching. Heat treatment prior to leaching has been surprisingly found to obviate the need for an oxidative or reducing leach additive while still producing high purity levels and selectivity in coprecipitation, particularly in an NMC cathode material. An alternative configuration demonstrates use of specific oxidative leach additives when no heat treatment is used prior to leaching.

The positive active electrode metals such as Ni, Co and Mn in the black mass formed from lithium-ion batteries have been commonly leached in acidic solution with the aid of a leach additive that is either an oxidizing agent or a reducing agent. For example, it is common to leach the black mass using a leaching agent that includes sulfuric acid as a preferred choice of the leach acid and hydrogen peroxide as a preferred choice of a leach additive. Hydrogen peroxide, when used in a leach agent, has been traditionally believed to function as a reducing agent to reduce higher oxidation states of metal ions to divalent metal ions during the leaching reactions. Conventional research has suggested that the combination of sulfuric acid and hydrogen peroxide improves metal leaching yields, particularly for the leach yield of manganese. However, there is a scientifically complex relationship that induces hydrogen peroxide to act as a reducing agent in acidic solutions. Hydrogen peroxide is preferably reduced to a hydroxide ion and tends to be neutralized to water in acidic solutions, thus acting as a strong oxidizing agent with a reduction potential=1.776 V. The following equations are illustrative:

$$\begin{matrix}{H}_{2} {O}_{2} ( a q ) + {H}^{+} ( a q ) + 2 {e}^{-} \to H 2 O ( l ) & {E}_{r e d}^{0} = 1.7 \; 76 V\end{matrix} \qquad ( 1 )$$

When H₂O₂ is oxidized (acting as a reducing agent),

$$\begin{matrix}{H}_{2} {O}_{2} ( a q ) \to {O}_{2} ( g ) + {H}^{+} ( a q ) + 2 {e}^{-} & {E}_{ox}^{0} = - 0.68 V\end{matrix} \qquad ( 2 )$$

As seen from equations 1 & 2, hydrogen peroxide is dominantly an oxidizing agent in aqueous acidic solutions and would only tend to act as a reducing agent in alkali solutions.

When hydrogen peroxide is mixed with sulfuric acid, it forms a strong acid (Caro's acid) or oxygen radical as seen from equations 3 & 4.

$${H}_{2} {SO}_{4} + {H}_{2} {O}_{2} \to {H}_{2} {SO}_{5} ( Caro ' s acid ) + {H}_{2} O \qquad ( 3 )$$

$${H}_{2} S {O}_{4} + {H}_{2} {O}_{2} \to {[ {H}_{3} O ]}^{+} + {HSO}_{4}^{-} + {O}^{} \qquad ( 4 )$$

Both Caro's acid and the oxygen radical are strong oxidizing agents. Based on the above equations, hydrogen peroxide operates as an oxidizing agent during leaching. The operative role would be 1) oxidatively destroying the PVDF (polyvinylidene fluoride) polymer coating on the positive active metal oxide particles and exposing particle surface area for free access of the acid to dissolve the metal oxides, unless the acid access is somewhat limited by hydrophobic coating on the material, and/or 2) oxidizing the metal-oxide bonds to weaken the bond strength and thus facilitating an ability for the sulfuric acid to dissolve the metal oxides. It may be beneficial to point out that recycled materials, in contrast to control or virgin materials, have previously been formed onto electrode sheets with a polymer binder (typically PVDF) and conductive particles.

In configurations disclosed herein, positive active metal oxide is successfully leached with the aid of a strong oxidizing agent, including peroxides such as hydrogen peroxide or persulfates such as sodium persulfate (NPS), as well as various hypochlorites, chlorites, chlorates, perchlorates, halides, permanganates, nitrates, nitrous oxide, nitrogen dioxide, ozone, or oxygen. For example, using NPS, examples herein demonstrate that use of a small quantity of a strong oxidizing agent noticeably improves the metal leaching of at least NMC from the black mass when compared with leaching in an absence of the oxidizing agent. When lower amounts of NPS (such as an NPS to NMC molar ratio=0.032) were used, nickel and cobalt leaching were still sufficient, but manganese leaching was reduced. When larger concentrations of NPS were employed (such as an NPS to NMC molar ratio=0.096), Ni, Mn and Co metal are almost completely leached.

Furthermore, heat treatment of the black mass prior to leaching has been found to be capable of achieving similar beneficial effects as leaching with a leach additive that is an oxidant. When the black mass is thermally treated at >400° C., it is believed that the polymer binder is burned out from the electro-active materials. Therefore, positive active metal ions from thermally treated black mass can be successfully leached in only sulfuric acid—that is, in the absence of a leach additive—with high leaching yields. The results below demonstrate that thermally treated black mass achieves similar high leach yields when using hydrogen peroxide as a leach additive. In other words, positive active metal leaching with or without hydrogen peroxide gives almost identical leaching yields as achieved when leaching heat-treated black mass. However, non-thermally treated black mass is adversely affected by an absence of hydrogen peroxide; the leaching yields are much higher with hydrogen peroxide compared with those without hydrogen peroxide. This is consistent with the polymer binder coating on the positive active materials being burned away in the heat treatment.

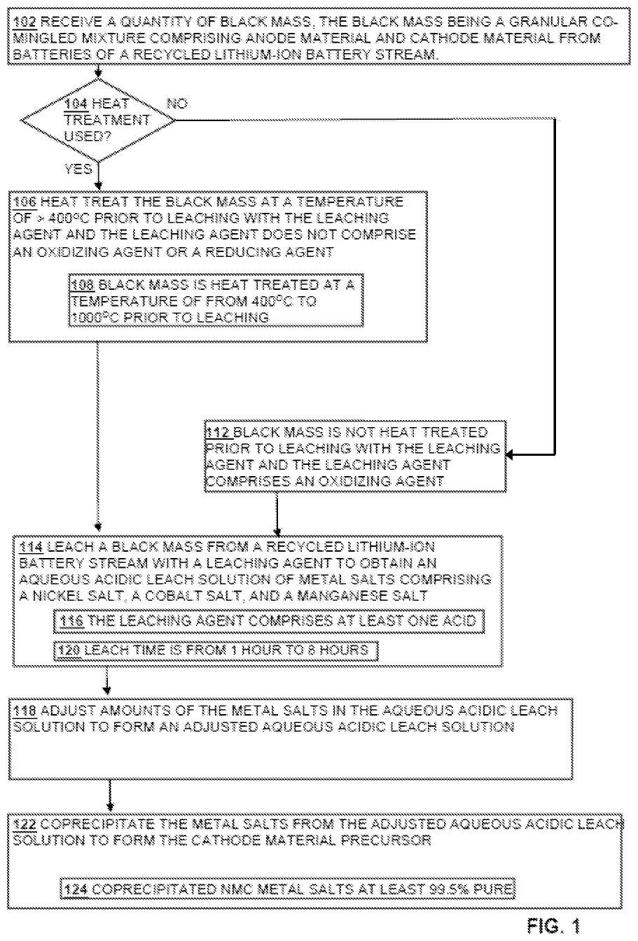

FIG. 1 is a process flow of black mass processing according to configurations herein. In a deployed configuration for NMC recycling, large quantities of black mass are received via the recycling stream and leached using a leaching agent. Leaching of the black mass preferably uses considerable amounts of leach solution (usually including an aqueous acid such as H₂SO₄), any leach additive used, and heat. It may be beneficial to eliminate the need for a leach additive to reduce costs. FIG. 1 depicts a comprehensive approach to achieving a high leaching yield of cathode materials from the black mass using either a leach additive or using heat treatment, but without needing both.

Referring to FIG. 1, the method for producing a cathode material precursor includes, at step 102, receiving a quantity of black mass via the Li-ion battery recycling stream. The black mass is a granular co-mingled mixture comprising anode material and cathode material from batteries of lithium-ion battery waste. The waste batteries may be end-of-life batteries or batteries prematurely retired due to vehicle failure or defect. A determination is made, as depicted at step 104, for heat treatment prior to leach.

If heat treatment is employed, the black mass is heat treated at a temperature of >400° C. prior to leaching with the leaching agent, and the subsequent leaching agent will not include a leach additive that is an oxidizing agent or a reducing agent, as depicted at step 106. In an example configuration, the black mass is heated at a temperature of from 400° C. to 1000° C. prior to leaching, as depicted at step 108. Other configurations may heat treat the black mass at a temperature of from 550° C. to 700° C.

If heat treatment is not employed, leaching occurs using a leaching agent that includes a leach additive that is an oxidizing agent, as disclosed at step 112. Typical oxidizing agents include a peroxide, a persulfate, a hypochlorite, a chlorite, a chlorate, a perchlorate, a halide, a permanganate, a nitrate, nitrous oxide, nitrogen dioxide, ozone, or oxygen. Alternatively, a reducing agent may be employed, or a leach additive that functions as a combined reducing agent and oxidizing agent.

Leaching of the black mass from the recycled lithium-ion battery stream with a leaching agent results in the formation of an aqueous acidic leach solution of metal salts comprising a nickel salt, a cobalt salt, and a manganese salt, as depicted at step 114. The leaching agent includes at least one acid, which is preferably water soluble, such as sulfuric acid, as shown at step 116, and optionally a leach additive as determined above. If needed or desired, the aqueous acidic leach solution can be filtered to remove any insoluble materials leached from the black mass, such graphite.

A predetermined ratio of the individual Ni, Mn and Co are significant for generating charge material according to the prescribed battery chemistry. Therefore, additional control metal salts are added to the metal salts in the aqueous acidic leach solution to form an adjusted aqueous acidic leach solution, as depicted at step 118. A typical leaching time is from 1 hour to 8 hours, as disclosed at step 120, and is followed by coprecipitation of the metal salts from the adjusted aqueous acidic leach solution to form the cathode material precursor, as depicted at step 122. The aqueous acidic leach solution may be filtered to remove insoluble materials prior to coprecipitating the metal salts.

Leaching may undergo several forms. In one example, the leach acid is an inorganic acid including one or more of sulfuric acid, hydrochloric acid, nitric acid, or phosphoric acid. Alternatively, the leach acid may be an organic acid including mono- or di-carboxylic acids having a carbon length of from 1 to 6. The leach acid and the metal salts are typically in a molar ratio of from 2 to 6, but other ratios may be employed. Similarly, if an oxidizing agent is used, the oxidizing agent and the metal salts may be in a molar ratio of from 0.02 to 0.3. A particularly beneficial oxidizing agent is sodium persulfate.

Leaching parameters may also vary in order to maximize leaching yield; a typical duration may be 8 or 10 hours. The temperature may be in a range from 75° C. to 100° C., or alternatively may maintain a range from 80° C. to 90° C.

In an example arrangement, using an NMC recycling stream, the aqueous acidic leach solution of metal salts includes the nickel salt, the cobalt salt, and the manganese salt in an initial ratio determined by the cathode material of the batteries of the recycled lithium-ion battery stream. Adjustment of the amounts of the metal salts in the aqueous acidic leach solution provides a selected ratio of metal salts in the adjusted aqueous acidic leach solution that is different from the initial ratio, to correspond to the preferred battery chemistry.

The example configuration generates coprecipitated NMC metal salts that are at least 99.5% pure, as disclosed at step 124. The resulting cathode material precursor typically includes nickel, manganese and cobalt in the selected ratio as prescribed by the desired recycled battery chemistry. To complete the recycling process to manufacture the recycled battery, coprecipitation causes the metal salts defining the cathode material to fall out of solution in a granular form.

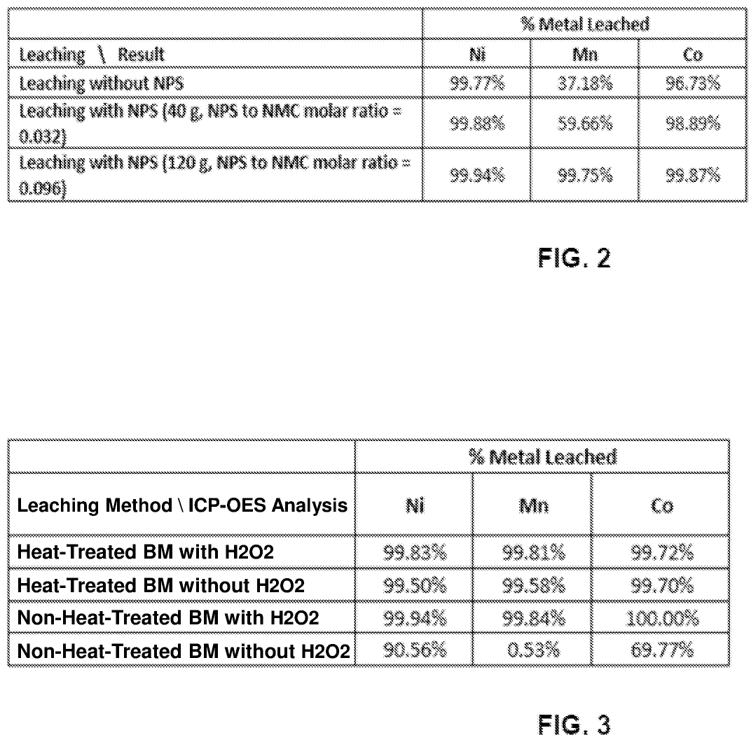

FIG. 2 is a result of an example in which sodium persulfate is used as a leach additive. Referring to FIGS. 1 and 2, 100 g of black mass was dispersed in 200 mL of deionized water with agitation. Concentrated sulfuric acid (93 wt %, 70 mL) and sodium persulfate (NPS; 40 g or 120 g) were added to the black mass slurry with agitation. Leaching of the metal salts was performed at 80° C.-90° C. for 4 hours. The solid matter was then separated out by vacuum filtration and the solid was washed with hot water to remove leached metal sulfate from the solid. The aqueous acidic leach solution (filtrate) was analyzed for metal concentrations by Inductively coupled plasma-optical emission spectroscopy (ICP-OES). For a control experiment, the same reaction was carried out without sodium persulfate (NPS). The results show that without NPS as a leach additive, the leached percentage decreases, particularly for Mn. The results suggest that a leach additive such as NPS is beneficial when heat treatment is not applied to the pre-leached black mass.

FIG. 3 shows results of a use case comparing heat treatment. Referring to FIGS. 1 and 3, 250 g of black mass thermally treated a >400° C. was dispersed in 360 mL of deionized water, and the slurry was mechanically agitated. Concentrated sulfuric acid (93 wt %, 152.5 mL) was added to the slurry and agitated. Then, hydrogen peroxide (35 wt %, 100 mL) was added to the slurry for the indicated trials. The slurry was leached at 80° C.-90° C. for 4 hours. After the reaction, undissolved solids were separated out by filtration, and the filter cake was washed with hot water to remove leached metal sulfate from the filter cake. The results indicate that either black mass heat treatment, hydrogen peroxide as a leach additive, or both, generate highly leaching yield for NMC, but the yield suffers, particularly for Mn, when neither heat treatment nor an H₂O₂ leach additive is employed.

While the system and methods defined herein have been particularly shown and described with references to embodiments thereof, it will be understood by those skilled in the art that various changes in form and details may be made therein without departing from the scope of the invention encompassed by the appended claims.

What is claimed is:

1. A method for producing a cathode material precursor comprising:
leaching a black mass from a recycled lithium-ion battery stream with a leaching agent to obtain an aqueous acidic leach solution of metal salts comprising a nickel salt, a cobalt salt, and a manganese salt,
adjusting amounts of the metal salts in the aqueous acidic leach solution to form an adjusted aqueous acidic leach solution, and
coprecipitating the metal salts from the adjusted aqueous acidic leach solution to form the cathode material precursor, wherein
a) the black mass is heat treated at a temperature of >400° C. prior to leaching with the leaching agent and the leaching agent does not comprise a leach additive that is an oxidizing agent or a reducing agent, or
b) the black mass is not heat treated prior to leaching with the leaching agent and the leaching agent comprises a leach additive that is an oxidizing agent and is selected from the group consisting of a peroxide, a persulfate, a hypochlorite, a chlorite, a chlorate, a perchlorate, a halide, a permanganate, a nitrate, nitrous oxide, nitrogen dioxide, ozone, or oxygen.

2. The method of claim 1, wherein the leaching agent comprises at least one acid.

3. The method of claim 2, wherein the acid is an inorganic acid selected from the group consisting of sulfuric acid, hydrochloric acid, nitric acid, or phosphoric acid.

4. The method of claim 2, wherein the acid is an organic acid selected from the group consisting of mono- or di-carboxylic acids having a carbon length of from 1 to 6.

5. The method of claim 2, wherein the acid and the metal salts are in a molar ratio of from 2 to 6.

6. The method of claim 1, wherein, when the black mass is not heat treated, the leach additive and the metal salts are in a molar ratio of from 0.02 to 0.3.

7. The method of claim 1, wherein, when the back mass is not heat treated, the leach additive is sodium persulfate.

8. The method of claim 1, wherein the black mass is leached at a temperature of from 75° C. to 100° C.

9. The method of claim 8, wherein the leaching temperature is from 80° C. to 90° C.

10. The method of claim 1, wherein the black mass is leached for a time of from 1 hour to 10 hours.

11. The method of claim 10, wherein the leaching time is from 4 hours to 8 hours.

12. The method of claim 1, wherein, when the black mass is heat treated, the black mass is heat treated at a temperature of from 400° C. to 1000° C. prior to leaching.

13. The method of claim 12, wherein the black mass is heat treated at a temperature of from 550° C. to 700° C.

14. The method of claim 1, wherein the black mass is a granular co-mingled mixture comprising anode material and cathode material from batteries of the recycled lithium-ion battery stream.

15. The method of claim 14, wherein the cathode material comprises at least one metallic element selected from nickel, manganese, and cobalt.

16. The method of claim 15, wherein the cathode material comprises nickel, manganese, and cobalt metallic elements.

17. The method of claim 14, wherein the anode material comprises graphite.

18. The method of claim 1, wherein the aqueous acidic leach solution of metal salts comprises the nickel salt, the cobalt salt, and the manganese salt in an initial ratio determined by the cathode material of the batteries of the recycled lithium-ion battery stream, and
wherein adjusting amounts of the metal salts in the aqueous acidic leach solution provides a selected ratio of metal salts in the adjusted aqueous acidic leach solution that is different from the initial ratio.

19. The method of claim 18, wherein the cathode material precursor comprises nickel, manganese and cobalt in the selected ratio.

20. The method of claim 1, further comprising filtering the aqueous acidic leach solution to remove insoluble materials prior to coprecipitating the metal salts.
